(19) United States
(12) Patent Application Publication
(10) Pub. No.: US 2013/0325347 A1
(43) Pub. Date: Dec. 5, 2013

(54) MEDIUM-LONG TERM METEOROLOGICAL FORECASTING METHOD AND SYSTEM

(71) Applicants: Michela Giorgetti, Milano (IT); Giuseppe Giunta, San Donato Milanese (MI) (IT); Raffaele Salerno, Chieri (TO) (IT); Roberto Vernazza, Sannazzaro De'Burgondi (PV) (IT)

(72) Inventors: Michela Giorgetti, Milano (IT); Giuseppe Giunta, San Donato Milanese (MI) (IT); Raffaele Salerno, Chieri (TO) (IT); Roberto Vernazza, Sannazzaro De'Burgondi (PV) (IT)

(73) Assignee: ENI S.p.A., Roma (IT)

(21) Appl. No.: 13/993,684

(22) PCT Filed: Dec. 13, 2011
(86) PCT No.: PCT/IB2011/055632

§ 371 Date: Aug. 9, 2013

(30) Foreign Application Priority Data
Dec. 15, 2010 (IT) MI2010A002303

(51) Int. Cl. G01W 1/00

(52) U.S. Cl. CPC G01W 1/00
USPC 702/3

(57) ABSTRACT

A method for medium-long term meteorological forecast starting from meteorological parameters of a large-scale geographical area having a predefined extent. The method: decomposes the meteorological parameters of the large-scale geographical area into a base component and a part arising as a variation on a regional scale, wherein the variation on a regional scale is defined as the difference between the large-scale geographical area and the base area; determines the temperature close to a surface of a base area, starting from the parameters available on the large-scale geographical area, using an empirical-statistical model; determines deviation in the meteorological parameters on a regional scale, starting from the parameters available on the large-scale geographical area, using a dynamic numerical model; effects combination, through an applicative model, of the empirical-statistical model and the dynamic numerical model to obtain the medium and long-term temperature forecast.

The present invention relates to a medium-long term meteorological forecasting method and system, which can be used in particular but not exclusively, for the management of energy resources and for the projecting and construction of industrial work sites and plants.

Numerical models forecasting long-term weather and climate (60-90 days), on a global and regional scale provide an alternative to the statistical systems deriving from the analysis of historical data. These models are based on the dynamic approach to the forecast of temperatures, rain and other weather and climate variables. Since, numerical models were used mainly for short-term weather forecasts (1-5 days) with a high degree of reliability.

The regional scale is defined, for the purposes illustrated herein, as between 10⁴ km² approximately and 10⁷ km² approximately. The upper limit (approximately 10⁷ km²) is the sub-continental scale whereby climatic non-homogeneities can be widespread in various parts of the globe. What takes place beyond this upper limit, i.e. on a planetary scale, is dominated by processes and interactions connected with a general circulation. The lower limit (approximately 10⁴ km²), on the contrary, represents the border between the regional scale and local scale. In recent years it has been demonstrated that these models also have a certain predictive capacity on seasonal time scales (3-6 months) (Kumar et al., 1996; Zwiers, 1996; Barnston et al., 1999; Mason et al., 1999; Goddard et al., 2001; Palmer et al., 2004). Experimental seasonal forecasts have been produced since 1997, for example at the IRI (International Research Institution), the University of Columbia and European Centre for Medium-range Weather Forecast (ECMWF).

For an effective application of seasonal-type forecasts, significant information must be available on regional and local scales. It is also well known that models are the main tool for the analysis of climate change and the development of future scenarios. These models offer the climatic simulations which include basic characteristics of the physics and dynamics of the atmosphere and take into account the interactions between the various components (atmosphere, oceans, earth, ice, biosphere). So far, the most advanced systems simulate the Earth climate, coupling the atmosphere with what is taking place in the oceans (Atmosphere-Ocean General Circulation Models, AOGCM).

The horizontal resolution, i.e. the distances between the points on which the model effects calculations, typically ranges from 50 to 250 km. Within these models, the physical processes which take place on a smaller spatial scale with respect to the resolution of the model are treated through suitable algorithms, generally called parameterizations.

AOGCMs provide a good description of the climate on spatial scales larger than their horizontal resolution, but they cannot provide a detailed description of the climatic variables under current conditions, or detailed projections relating to their modifications on scales lower than the same resolution. In recent years, the increase in the resolution of models on the global scale has also allowed information on a regional scale to be provided. In spite of this, in most of the models used in seasonal forecasts there is still a deficiency in the spatial resolution, which does not allow realistic values of the weather and climatic variables to be determined. In particular, the predictability of the temperature can be limited as this variable is particularly sensitive to the complexity of the territory.

In recent years, models have been used on a regional scale or for a limited area in long-term forecasts, inserting them within global models for producing regional and local wheather and climate information. These models are able to take important local factors into account, such as for example the influence of orography. In this way they are consistent and capable of providing significant responses to a wide range of physical parameters. These models are based on the same fundamentals as high-resolution models for weather forecasts, such as those produced by the Epson Meteo Centre (CEM). High-resolution models have been used within the CEM for 15 years for producing meteorological information on a global scale. In 2002, an experimental activity was initiated for the production of seasonal forecasts based on a so-called two-tiered approach. This approach is characterized in that the boundary conditions, such as the sea-surface temperatures (SST), are predicted and used as a forcing element of the overlying atmosphere. SSTs can be determined from climatological temperatures on the basis of the anomaly present at the starting moment, and also completely predicted by an AOGCM model.

An objective of the present invention is therefore to provide a medium-long term weather forecasting method and system which is capable of solving the above drawbacks of the known art in an extremely simple, economical and particularly functional manner.

More specifically, an objective of the present invention is to provide a medium-long term weather forecasting method and system which allows the management and evaluation of natural gas reserves, in addition to the purchasing and sale phases of the same, with particular interest on a European, national and macro-regional scale.

A further objective of the present invention is to provide a medium-long term weather forecasting method and system which allows an estimation of the electric energy production obtained with the use of natural gas.

Another objective of the present invention is to provide a medium-long term weather forecasting method and system which allows a more effective management of work-sites which envisage the transport of materials, off-shore exploration, the construction of industrial plants or pipelines in any geographical area.

Seasonal wheather and climate forecasts must be considered as a continuous process from short to long term (“seamless prediction” concept). A combined “atmosphere-ocean-earth-ice” system shows a wide range of physical and dynamic phenomena, with which physical and biochemical reactions are associated. They form a continuous combination in which a space-time variability is exerted. The boundary between weather and climate is absolutely artificial and, as such, tends to inhibit interactions between the components of the physical system. The climate on the global scale, in fact, influences the environment as a whole, at the microscale and mesoscale. This, in turn, influences the local weather and climate. Furthermore, small-scale processes have a significant impact on the evolution of large-scale circulation and on interactions between the various components of the climatic system.

The central point of the method and system according to the invention therefore consists in the prediction on a space-time scale of this “continuous combination” and interactions between the various components of the physical system. The seamless prediction concept therefore becomes the explicit paradigm for recognizing the importance and benefits in the convergence of the methods and technologies used in the field of weather and climate forecasts. Particular attention must be paid to the initialization of the climatic system, as every phenomenon, from those on an hourly scale to those on a weekly scale, benefits from an accurate definition of the initial conditions of the whole climatic system.

The development of a unified prediction approach, which eliminates the gap between the prediction of a short-term meteorological event and seasonal variations, starts from uniting the specific seasonal forecast activities and so-called ensemble methods. The term “seasonal forecast” refers to a forecast which covers a period of 30 to 90 days (season). The term “ensemble”, on the other hand, refers to the joining of simulations made by a mathematical weather forecast model. Each simulation (run) uses a set of data, consisting of meteorological variables provided by observation systems of the atmosphere data on the global scale, for example weather stations, satellites, etc. The number of runs which form the ensemble is variable and is equal to the number of perturbations applied to the observed initial values revealed, by which the model is initialized. The approach must necessarily contemplate a mechanism which comprises the use of various mathematical models and/or the use of various physical and dynamic schemes (multi-models).

The multi-model approach is necessary as the models are simplified and imperfect tools, and the use of various dynamic and physical systems is therefore more reliable, in principle, than the perturbation of the initial conditions of a single model. The multi-model approach therefore becomes a simple and consistent way of perturbing physics and dynamics in weather forecasts. Through the multi-model perturbation approach of the initial state, a stronger and more effective forecast system is obtained. Furthermore, by verifying the hypotheses on more than one model, it is possible to verify which result is independent of the model itself and therefore probably more reliable.

Interactions on the different space-time scales are the dominating characteristic of all aspects of weather and climate forecasting. The prediction of any climatic anomaly on a region is only complete by effectively evaluating the effects of seas, land, vegetation and stratospheric processes. Furthermore, seasonal forecasting requires that the models be capable of providing a realistic representation of the fluctuations of the atmospheric weather day-by-day. These fluctuations modify the statistical correlation on a local scale and therefore they must be taken into account in the changes of the system which alter their prediction. The combination of atmospheric weather and climate in a single aspect implies the use of realistic models which include interactions between the components of the weather and climate system and which, at the same time, are capable of predicting the main anomalies of the weather and climate parameters and of the weather day-by-day.

There are well-documented reasons at the basis of the use of different approaches between atmospheric weather and climate (Barry et al., 2009). In a short-term forecast, the deterministic evolution of the weather is a problem linked to the values used for initializing the model. For weather on a climatological scale, on the other hand, the statistics of the atmospheric systems are the most important element.

In seasonal forecast, the interaction between the various components of the weather and climate system represents the fundamental element and paradigm of forecasting itself which ranges from short to long terms. The importance and considerable benefit in the convergence of the methods used in weather forecasts and climatic forecasts, can be clearly acknowledged.

The characteristics and advantages of a medium-long term wheather and climate forecasting method and system which can be used in particular but not exclusively for the handling of energy resources and for the planning and construction of work-sites and industrial plants, according to the present invention, will appear more evident from the following illustrative and non-limiting description, referring to the enclosed schematic drawings, in which:

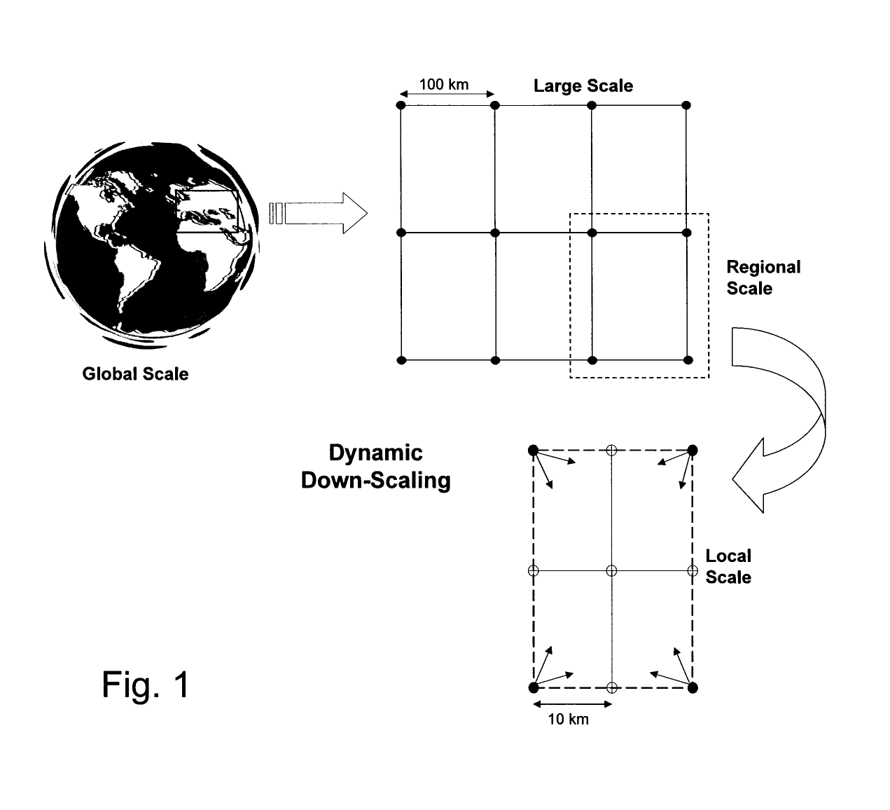

FIG. 1 is a block scheme which illustrates a process for determining meteorological parameters used in the wheather and climate forecasting method and system according to the invention;

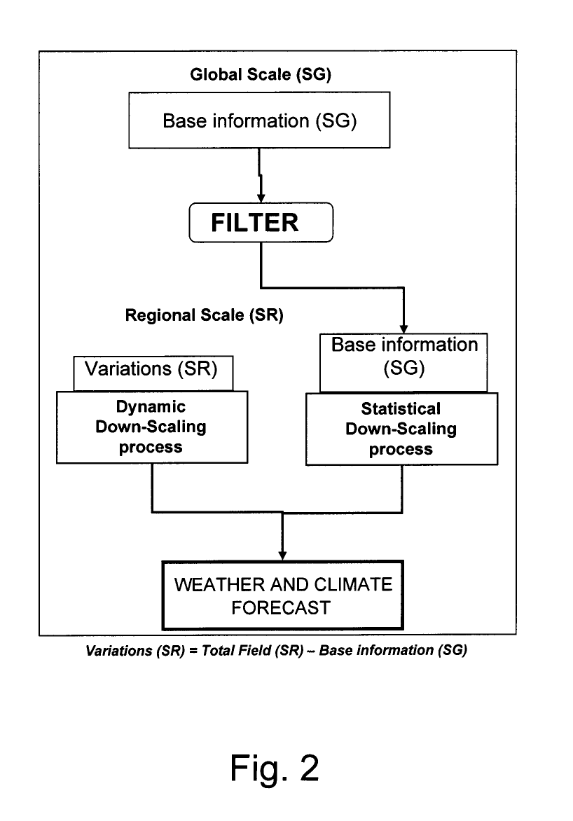

FIG. 2 is a block scheme which illustrates another process used in the wheather and climate forecasting method and system according to the invention;

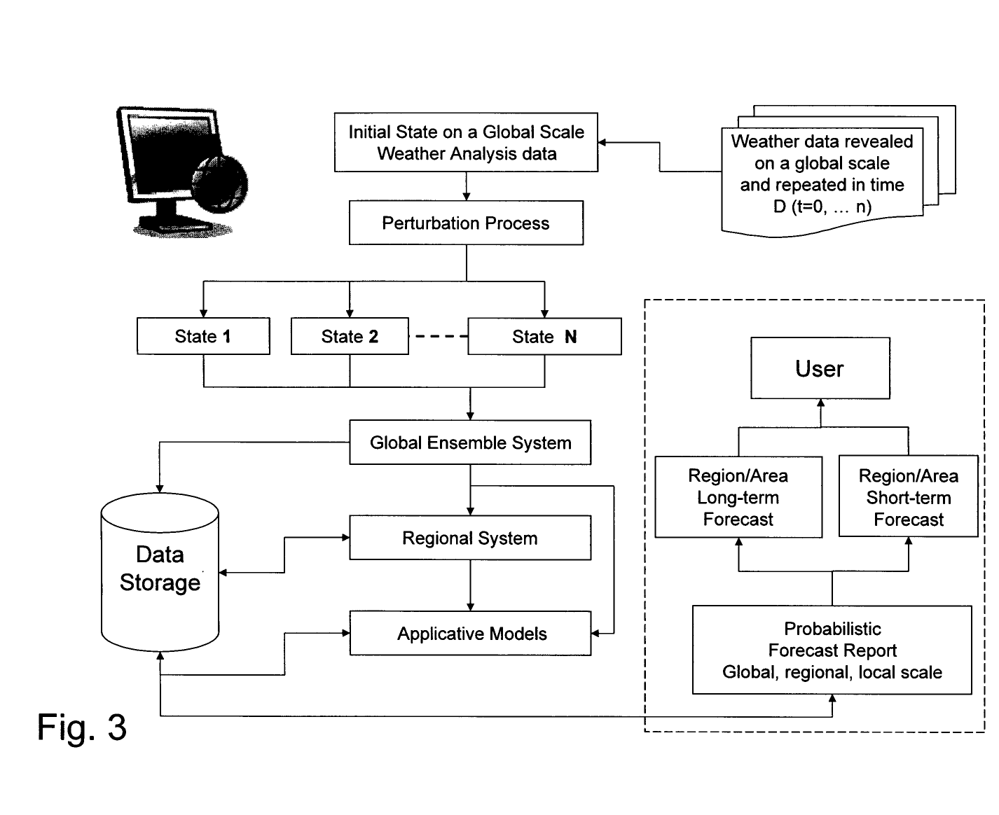

FIG. 3 is a block scheme which illustrates the phases and main components of the wheather and climate forecasting method and system according to the invention;

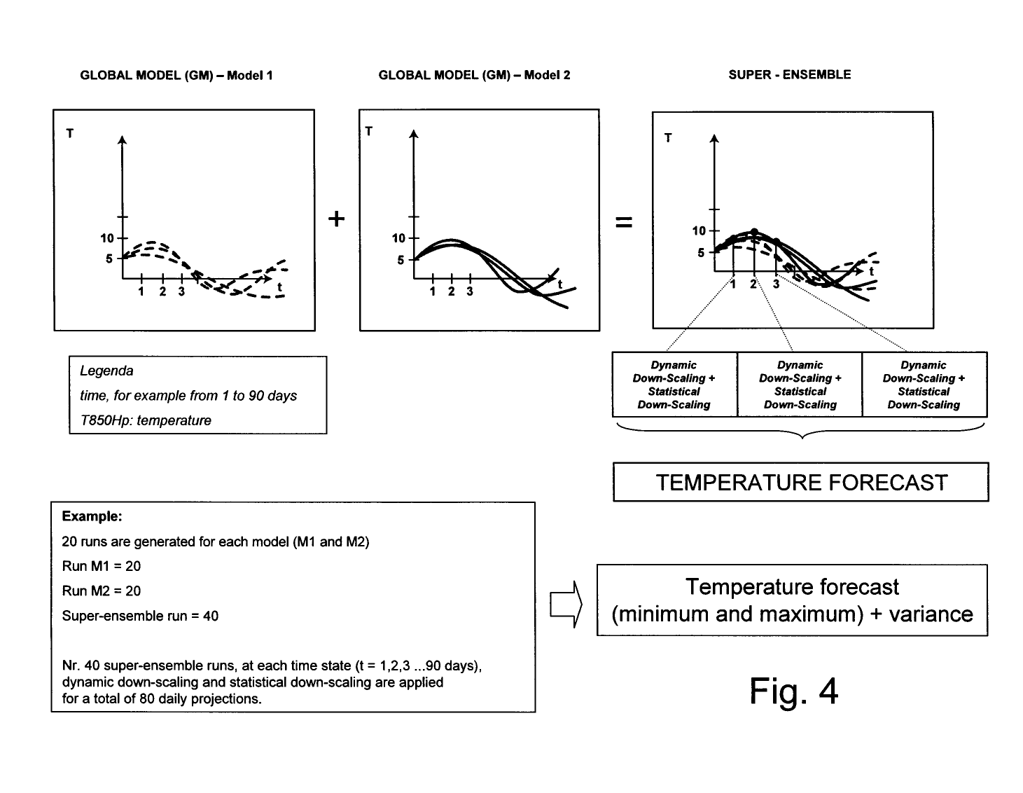

FIG. 4 is a scheme which illustrates a combination of simulations performed by a mathematical weather forecasting model; and

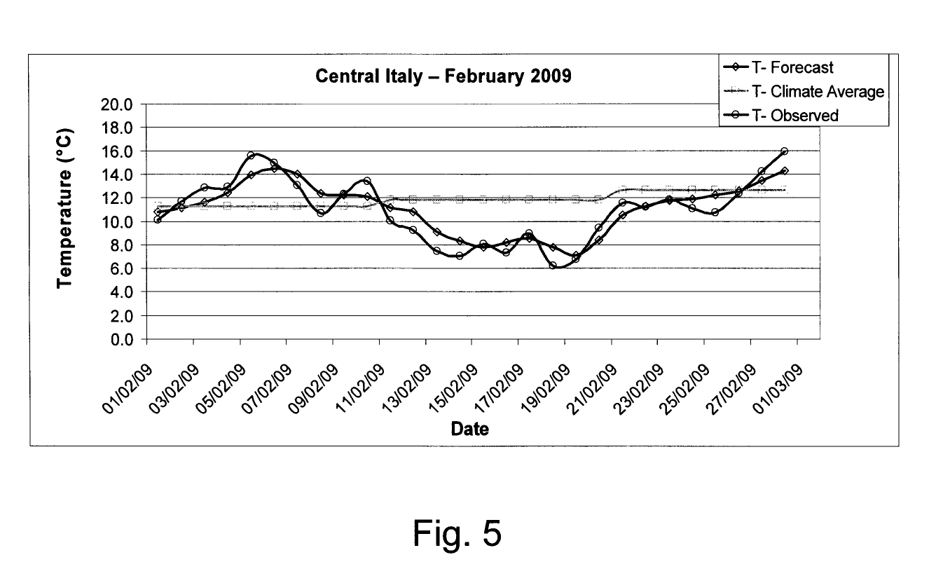

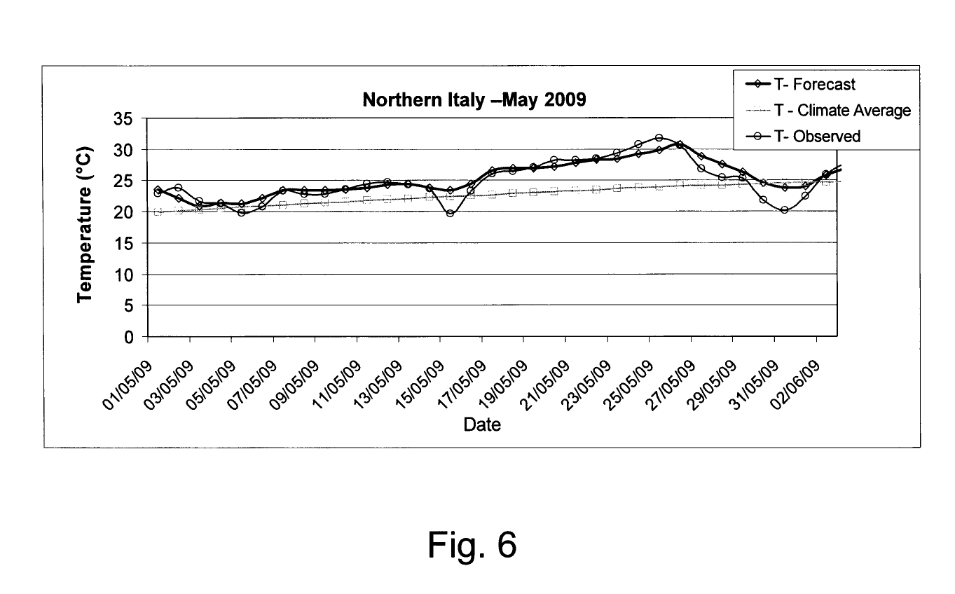

FIGS. 5 and 6 are graphs which show two distinct forecast examples of the maximum temperature obtained in certain time periods and in certain geographical areas, wherein the forecasts obtained by means of the method according to the invention (lines with rhombs) are respectively compared with the temperatures observed (lines with circles) and with the climatic averages over 25 years (lines with squares).

The medium-long term wheather and climate forecasting method according to the invention is based on the composition of the forecasts and application to geographical macro-areas of interest using a new, so-called, down-scaling system. The term down-scaling means a process for determining local meteorological parameters starting from parameters available on a larger spatial scale. In the method according to the invention, the combination of simulations is generated starting from the perturbation of the initial atmospheric conditions using global and regional models. This allows the development of wheather and climate forecast in a probabilistic sense.

In short, the medium-long term wheather and climate forecasting method according to the invention:

combines dynamic systems with statistic systems through an applicative model;

combines the application of the time tendency to seasonal forecasting on a global scale according to the end-to-end approach (observation, prediction, application and decision), which forms one of the basic elements of the invention;

uses an ensemble down-scaling method for providing a short-, medium- and long-term (seasonal) wheather and climate forecast. The expression ensemble down-scaling means the application of the down-scaling process (statistical and dynamic) to each simulation (run) effected by the models on a global scale.

Two phases were implemented, and subsequently integrated with each other, for the simulation and wheather and climate forecasting on a regional scale:

the first phase envisages the use of a limited area models, with a grid step size ranging from 1 km to 20 km and typically in the order of 10 km, and the boundary conditions provided by the ensemble on a global scale;

the second phase envisages the use of empirical-statistical models for the connection between the local wheather and climate characteristics and conditions on a regional scale.

The two phases were joined and applied simultaneously to the various members of the ensemble, so as to create a statistical-dynamic ensemble down-scaling.

The climate of a region is determined by the interaction between the processes and circulation which act on a global, regional and local scale respectively, and within a wide time range which varies from hours to weeks (Zhang et. Al., 2006). Processes which regulate the general circulation of the atmosphere belong to the planetary scale. These are the elements which determine the sequence and type of meteorological events-regimes which characterize the climate of a region.

Within the planetary scale, the local and regional effects modulate the spatial and time structure of the regional climatic signals, causing effects which, in turn, are capable of conditioning the characteristics of the general circulation. Furthermore, the climatic variability of a region can be strongly influenced, through the so-called tele-connections, by anomalies present in distant regions, which complicate the evaluation of climatic variations on a regional scale. These anomalies are characterized by different time scales and high non-linearities.

According to the invention, a multi-scale approach is considered for determining the processes which regulate changes in climate on a regional scale. At the beginning of the process, there is the ensemble on atmosphere-ocean models, capable of reproducing the wheather and climate system with forcing elements on a planetary scale and the variability associated with induced anomalies on a large scale. The information which can be obtained is enriched, through the statistical-dynamic ensemble down-scaling method in processes on a regional and local scale.

In the ensemble down-scaling method, a selection process of each meteorological parameter of a super-ensemble is applied, for each time period, through a measurement based on the distance between suitably selected reference values. This measurement is used for excluding all values outside the range. The overall value is then re-calculated on the residual meteorological parameters, whereas the confidence range is based on the limits of the sub-ensemble obtained. The term super-ensemble means the combination of the simulations obtained from two (or more) weather forecast models. In the case of the present invention, the super-ensemble combines the results obtained from two simulation models on the global scale.

In this way, it is possible:

evaluate the variability associated with transitory meteorological events, in particular extreme events;

define the predictability and forecasting limits within a season;

define the confidence range in order to determine the degree of uncertainty:

provide a better support for the decision by the high-resolution modeling system which allows a prediction of the weather and climate to be obtained with continuity, containing a mechanism which links surface processes with physical and dynamical processes of the wheather and climate system.

The role of high-resolution forcing agents has been clearly demonstrated in several studies (among which, Noguer et al., 1998). These studies have demonstrated that the simulation capacity of the mesoscale component of the climatic signal is only modestly sensitive to the quality of the carrier data.

The importance of land and surface interactions on long-term simulations has also been demonstrated in numerous works in literature. The impact of the use of physical variables characteristic of the land and its changes on the climate on a regional scale has also been defined in various studies carried out in the past (among others, Pan et al., 1999; Pielke et al., 1999; Chase et al., 2000; Zang X., 2006). These characteristics are directly connected to the prediction of the phenomenon, as shown by the studies carried out at the Epson Meteo Centre on the Indian and Himalayan region, with respect to the interaction between the land and the atmosphere.

The prediction of the surface temperature, a central result of the method according to the invention, can greatly benefit from the improvement in the description of surface parameters. For this reason, according to the invention, the creation of an advanced database of climatic parameters has been created, to which surface parameters and the relative anomalies can refer.

The specific feature of the method according to the invention lies in the use of a global model, for the simulation of large-scale effects, and a regional model, to take into account characteristics on a lower scale, taking forcing elements into consideration in the regional scale. This technique was founded in the pioneering works of Dickinson et al. (1989) and Giorgi (1990).

The concurrent technique, known in literature, uses a statistical representation of mesoscale characteristics. The statistical down-scaling method is based on the fact that the climate on a regional scale is conditioned by two factors: the large-scale base state and the local and regional physiographical characteristics. Local and regional information is obtained starting from a statistical model which connects the large-scale wheather and climate variables to the regional and local variables.

The method according to the invention proposes an innovation of the ensemble down-scaling procedure, which combines the statistical technique with the dynamical technique. The system generates an application layer capable of providing weather and climate forecast of the temperature (continuous prediction from short to long term) for direct use in the decisional process, also providing the confidence of the forecast. In this way, the final user possesses of useful information for undertaking actions correlated to the objectives proposed, in particular:

exploring possible options for evaluating alternative decisions based on the probability of specific climatic events;

comparatively evaluating alternatives in relation to the objectives of the business.

In this way, it is possible to obtain an economic evaluation of the weather and climate forecast and identifies potentially anomalous situations.

More specifically, the medium-long term wheather and climate forecasting method and system according to the present invention proposes to:

improve the description of the physical elements in the mathematical models used in wheather and climate simulations, in order to increase the performances of the models themselves;

apply multi-model ensemble methods for optimizing the simulations obtained from the single models, in itself incomplete;

create a statistical classification on the wheather and climate data registered in the last 30 years of the physical variables calculated by the models, in order to refine the prediction of temperature on a regional scale.

In general, weather and climate forecast needs to improve the statistical representation of the movements on a synoptic and sub-synoptic scale, without artificial limits between short-, medium- and long-term forecasting, and represent the interaction of these with the global climatic system. If the initial conditions are forgotten by the system with time, on the other hand, they enormously influence short- and medium-term phenomena (undulations) which normally belong to the time scale in the order of days. These high-frequency undulations are also indirectly propagated on wider time scales and influence what is happening on a large scale, revealing the link between atmospheric weather and climate.

In the method according to the invention, regional models are used for dynamically producing an analysis of the high-resolution atmosphere and for solving particular problems which cannot be solved on a large scale. With the use of the dynamic down-scaling method, all the details on a local scale are simulated without knowledge of the direct values within the regional domain (FIG. 1). The dynamic down-scaling method maintains the large-scale elements, resolved by the global model, and adds information on a reduced scale that the global model is not capable of solving.

The regional model must not alter the solution on a large scale: long false waves can develop however in the interior due to the effect of systematic errors. These waves interfere with the shorter waves, distorting the regional circulation and having an impact on physical processes by distorting the fields of the atmospheric variables (for example, temperature, pressure, etc.). Numerous regional models predict the fields within their domain without knowing the large-scale characteristics solved by the global model, except in the area close to the side boundary. The interior of the large-scale domain consequently does not known anything about the small-scale domain.

The information at the boundary of the small-scale domain (provided by the large-scale model) propagates in the domain itself, transferring the large-scale information to the interior. This process, however, creates systematic errors in the regional domain (FIG. 1). To avoid this, according to the invention, a “dynamic perturbation” method is adopted. In short, as shown in FIG. 1, the geographical field or area on which the weather forecast is effected, is divided into a base part and a part which arises as a variation on a regional scale (SR). The base part derives from the information of the global model (SG) on the regional area, whereas the variation is defined as the difference between the total field and the base part. The model calculates the tendencies of this variation for each atmospheric variable as the differences between the tendencies of the overall field and those of the base part. With a mathematical operation, the wave of greater length than those on a regional scale is filtered, so that all that happens on a larger scale remains unaltered. In any case, however, the physics on all the scales is kept in common for each scale and, within the domain, the long waves are free to develop in the regional model. Furthermore, there is no explicit forcing agent towards the global scale field within the regional domain. At this point, the regional model is still susceptible to large-scale errors. A further filter, based on a selective corrective mechanism, is applied for reducing this last type of error (FIG. 2).

In the combination between statistical and dynamic down-scaling, statistical down-scaling is applied to the base field, whereas dynamic down-scaling is applied to variations on a regional scale. In this way, the dynamic-statistical combination respects the conditions described above for the correct evaluation of the waves with different scales, indicating ensemble down-scaling as the composition of the possible undulations on a global and regional scale.

It should be noted that dynamic down-scaling on a regional scale (or even local), even if made by the same model, is different from weather forecasting on the same scale, as the two have different objectives even if, as already specified, conceptual continuity is ensured by the fact of using the same instrument. The objective of down-scaling is to obtain details on a regional scale starting from what is available on a global scale. The objective of weather forecasting is to produce a prediction in the regional domain which is not only a particularization of what is taking place on a global scale. Regional forecasting, in fact, is an improvement in the large-scale field produced by the global model. In down-scaling, the objective is not to modify the large-scale field, but to add specific details of the regional scale. There is a link, however, consisting of the fact that some processes are specifically of a regional scale and must be reproduced for creating a complete detail for that scale, even if the larger-scale field can be considered accurate.

The down-scaling procedure of the method according to the invention, is capable of taking into account the development of processes which take place on a smaller scale and for durations of less than a day, improving the prediction of the temperature close to the surface which can be specifically influenced by the evolution of these interactions on a smaller space-time scale. These effects can therefore be added to the global field, integrating some evolutionary aspects with the specific down-scaling particularization process as a combination of the base field, large-scale component of the total field, indicated in the regional scale. This allows the statistical component to be added, which relates the data of the field on a global scale with the regional dynamics and the final result, i.e. the temperature close to the ground.

The link between dynamic and statistics eliminates potential weaknesses of the only statistical down-scaling, due to the fact that the statistical correlation developed today do not necessarily also apply, as such, to the future, and the incompleteness of the data on certain areas. A scaled temperature field is therefore produced on the area of interest, on the basis of the ensemble down-scaling already illustrated above, homogenizing the space-time scaling, giving the process continuity and using the same instruments at each step.

The process, as shown in FIG. 3, is organized starting from overall data on a global scale, i.e. the state of the weather (weather data observed). These data serve for the construction of the starting point, i.e. the instant at time=0 (initial state on a global scale). The data are thus used to prepare the input of the module which generates perturbed states (perturbation process) starting from the initial state. Each of these perturbed states (state 1, state 2, . . . , state N) forms the starting point for each of the simulations of the model.

A simulation is produced from each perturbation, for each of the states used at the start, which covers the whole reference period. The results are stored and used contemporaneously for simulations on a regional scale (data storage⇄regional system) at the base level starting from the control run. The data of the simulations of the N states stored are the input of the applicative models which effect the down-scaling of seasonal forecasting, through the mechanism described hereunder. The data of the simulations, which are daily stored in the previous days, together with those of the current day, are used as a whole for constructing an ensemble consisting of hundreds of elements. At the end, an overall prediction is produced for the different groups of time scales, for current application according to the requirements of the user, in long-term forecast and in the usual short and medium-term one.

The down-scaling mechanism responds to the necessity of providing additional information starting from global forecasting. Regional scale models have been frequently used for down-scaling in the climatic range (for example for studying climatic changes) but rarely applied to seasonal forecasting. The method according to the invention is capable of overcoming any method previously applied, by down-scaling global forecasts through a combined use of regional models and statistical down-scaling. The latter is based on a mathematical model and an application which uses correlations constructed on the historical basis, thus allowing the model to be linked to the preselected regional domain. The regional model is able to down-scaling for each of the seasonal forecasting periods. Each period consists of different predictions, produced in the same period, thus constructing ensembles consisting of hundreds of elements which combine the statistical-dynamical properties of the system.

The results show that the combination between the global super-ensemble, dynamic-statistical down-scaling and inclusion of the tendency of the overall ensemble over a specific time period, combined through an application layer which constructs the average values, the confidence range and variability, forms, as a whole, a single and innovative system, capable of providing a continuous forecast over the whole seasonal period (FIG. 4).

A series of applicative examples of the medium-long term weather and climate forecast method according to the invention is provided hereunder. In Western economies, about 20% of PIL can be directly influenced by the wheather and climate conditions and the income of any industry in the agricultural, energy, construction, transport and tourism industries depends on the trend of meteorological variables, in particular the temperature, on which the method according to the invention is focalized. The weather conditions directly influence the volumes, uses and prices of certain goods. An exceptionally hot winter, for example, can leave energy companies with an excess of fuel reserves or, on the contrary, a colder winter creates the necessity of purchasing reserves at extremely high prices. Although the price changes in relation to the demand, price adjustments do not compensate possible losses deriving from an anomalous trend of the wheather and climate conditions. The method according to the invention determines short, medium and long-term temperature prediction and confidence, allowing intrinsic risks of the wheather and climate trend to be handled.

A first application example is the following. FIG. 5 represents the forecast effectively produced by the method according to the invention for the month of February 2009 for Central Italy. The forecast of FIG. 5 was generated at the beginning of the month of January 2009. As can be observed from the graph, there is a strong negative heat anomaly in the central part of the month of February, which the forecasting method was able to reproduce accurately, with a difference of only 0.9° C., with respect to a climatic variation of 2.4° C.

A second application example of the method is indicated in FIG. 6 for the prediction of the maximum temperature over Northern Italy for the month of May 2009. The forecast was computed on the basis of the processes previously described and the basis of the data processed refers to the end of March 2009. The forecasting method correctly reproduces the behaviour of the temperature measured in Northern Italy. The average variance is 1° C., whereas the difference compared to the climatic value used as a comparative value is 2.9° C. The method therefore provided a prediction improved by 1.9° C. with respect to the forecast based on the climatic values. In both of the applicative examples, the climatic anomalies in the order of 2° C. were correctly predicted.

With knowledge of the weather and climatic trend in advance, a considerable economical advantage can be obtained in terms of both price and volumes of gas. By knowing the temperature trend of a certain geographical area in time, in fact, and paying particular attention to anomalous trends, it is possible to improve the planning of storage reserves, sale and supply of gas.

Another application example of the method according to the invention relates to the prediction of the demand for gas, effected on the composition of residential, commercial, industrial demands and electric energy production. Energy demand is strictly correlated to the seasonal weather and climatic trend and in particular the term heating degree day (HDD) or cooling degree day (CDD) is used, depending on whether this refers to heating or conditioning. Problems relating to storage and gas reserves also depend on the demand. The balance between reserves and demand minimizes the risk of sudden price increases. High prices in fact correspond to peaks, as in certain cold winters, when the demand exceeds the sum of the production plus what has been accumulated in storage. The reserves themselves play a critical role in satisfying a growing demand. A balanced economic programming however requires an optimization of the quantity of natural gas to be stored. Excesses are costly whereas, on the contrary, an underestimation represents a considerable risk.

In order to evaluate the example of application to this problem of an accurate knowledge of wheather and climate forecasting and its impact, the dependence of each element of the demand on the degrees/day and its deviation with respect to the climatology, must be evaluated. In studies effected, the dependence on the degrees/day of the four terms of the demand (residential, commercial, industrial and electricity production) shows a relative insensitivity to the weather conditions for industrial demand, a weak dependence for commercial demand and a significant dependence for residential demand and the one associated with utilities. In particular, assuming a direct linear relation between the demand for natural gas and HDD (heating degree day) in the winter period (November-March), the weight on the dependence on the demand, in the case of a hypothetical variation of 2° C. (see FIG. 3) with respect to the climatological value, would cause:

an increase in the commercial and residential demand of about 20%;

an increase in the industrial demand of about 8%; and

no increase in the utilities demand, for an overall variation in the order of 10+15% with respect to the global demand.

In the same way, assuming a direct relation between the CDD (cooling degree day) and the demand for natural gas linked to the production of electric energy (utilities) in the summer period, with a variation of one degree with respect to the climatological value, a variation in the overall demand of about 7% can be estimated.

It can thus be seen that the medium-long term wheather and climate forecasting method and system according to the present invention achieves the objectives previously indicated.

The medium-long term wheather and climate forecasting method and system thus conceived can in any case undergo numerous modifications and variants, all included in the same inventive concept. The protection scope of the invention is therefore defined by the enclosed claims.

1-10. (canceled)

11. A method for a medium-long term meteorological forecast starting from meteorological parameters of a large-scale geographical area having a predefined extent, comprising:
decomposing the meteorological parameters of the large-scale geographical area into a base component and a part that arises as a variation on a regional scale, wherein the variation on a regional scale is defined as the difference between the large-scale geographical and the base area;
determining a temperature close to a surface of the base area, starting from the parameters available on the large-scale geographical area, using an empirical-statistical model;
determining a deviation in the meteorological parameters on a regional scale, starting from the parameters available on the large-scale geographical area, using a dynamic numerical model; and
effecting a combination, through an applicative model, of the empirical-statistical model and the dynamic numerical model to obtain the medium and long-term temperature forecast.

12. The method according to claim 11, wherein tendencies of the variation on a regional scale, for each meteorological parameter, are calculated as the differences between tendencies of the large-scale geographical area and tendencies of the base area.

13. The method according to claim 11, further comprising a filtration, based on a selective correction mechanism, of the meteorological parameters available on the large-scale geographical area.

14. The method according to claim 11, further comprising a selection, for each time spell, of temperature available on the large-scale geographical area through a measurement based on a distance between suitably selected reference values, the measurement being used to exclude all those values outside a range.

15. The method according to claim 14, further comprising a further calculation of an overall value on temperature ranges.

16. The method according to claim 11, further comprising a preliminary determining meteorological parameters suitable for constructing an initial time instant on the large-scale geographical area, which forms an input of a module that generates a plurality of disturbed weather states (state 1, state 2, . . . , state N) starting from an initial time instant, each of the disturbed states representing a starting point for combination of the empirical-statistical model and the dynamic numerical model for determining the temperature close to the surface.

17. he method according to claim 16, wherein for each of the disturbed states (state 1, state 2, . . . , state N) an overall simulation is produced, which is aggregated and covers a whole reference period.

18. The method according to claim 17, wherein results of the simulation are filed in a database and are contemporaneously used for simulations on a regional scale at the base level starting from control datum, the results forming the input of the empirical-statistical model and/or the dynamic numerical model to obtain the temperature forecast.

19. The method according to claim 11, wherein the part of the large-scale geographical area that is determined as a variation in the meteorological parameters on a regional scale has a grid step size ranging from 1 km to 20 km, or on an order of 10 km.

20. The method according to claim 11, wherein the meteorological parameter is a temperature value close to the surface.
